(19) United States
(12) Patent Application Publication
(10) Pub. No.: US 2008/0261138 A1
(43) Pub. Date: Oct. 23, 2008

(54) ELECTROSTATIC LATENT IMAGE DEVELOPING TONER

(75) Inventors: Mikihiko SUKENO, Tokyo (JP); Yoshiaki KOBAYASHI, Tokyo (JP); Michiaki ISHIKAWA, Kanagawa (JP); Tsuyoshi UCHIDA, Tokyo (JP); Masaharu SHIRAISHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/972,984

(22) Filed: Jan. 11, 2008

(30) Foreign Application Priority Data
Mar. 22, 2007 (JP) 2007074312

(51) Int. Cl. G03G 9/10

(52) U.S. Cl. 430/108.6; 430/110.3

(57) ABSTRACT

An objective is to provide an electrostatic latent image developing toner exhibiting ultra-low temperature fixability together with high resolution, excellent fluidity and anti-blocking property, and excellent aging stability in a toner vessel, in which the toner is supplied into an image forming apparatus. Also disclosed is an electrostatic latent image developing toner stored in a vessel possessing an ejecting outlet, capable of fitting into an image forming apparatus, wherein the vessel has a cross-sectional area of the outlet of 0.07-2.00 cm²; the toner possesses a resin, a colorant and an external additive; the toner has a Tg of 16-44° C.; an X-ray intensity ratio of Ti/Si via fluorescent X-ray analysis of toner, is 1.0-2.5; and toner particles, and having a ratio of 2^{nd} short axis to 1^{st} short axis being 1.1-1.6 have an amount of 5-50% in terms of the number of particles.

### TECHNICAL FIELD

The present invention relates to an electrostatic latent image developing toner.

### BACKGROUND

Presently, dry system toner development is conducted in image forming apparatuses such as copiers, printers and facsimile machines. In this case, the image forming apparatus is fitted with a vessel such as a toner bottle or a toner cartridge in which a dry system electrostatic latent image developing toner (hereinafter, referred to simply as toner) is stored, and the toner is designed to be supplied to a developing device from this toner vessel.

Accordingly, the toner vessel can inhibit toner leakage steadily during storage and conveyance, and the toner leakage is prevented when exchanging a toner vessel for another since the toner vessel is easily removable from the image forming apparatus. Further, intensive studies in this field are actively done even now since the toner vessel which is not high in cost, and also collective and recyclable is demanded (Patent Documents 1 and 2).

On the other hand, specifically in the case of digital image formation, toner image formation exhibiting excellent fine line reproduction and high resolution is demanded, and chemical toner typified by polymerization toner is provided as toner satisfying such the demand, but expected is the development of ultra-low temperature fixing toner to which a polymerization toner technique is applied (Patent Documents 3 and 4).

Further, when the low temperature fixing toner is stored for a long duration in the situation where it is charged in an image forming apparatus, toner particle-to-toner particle adhesion or toner adhering to a toner vessel occurs depending on the environment conditions, whereby there has been a problem such that a toner supply amount from an ejecting outlet of a toner vessel tends to be insufficient.

(Patent Document 1) Japanese Patent O.P.I. Publication No. 2006-163365

(Patent Document 2) Japanese Patent O.P.I. Publication No. 2005-300911

(Patent Document 3) Japanese Patent O.P.I. Publication No. 2006-250990

(Patent Document 4) Japanese Patent O.P.I. Publication No. 2005-234083

### SUMMARY

The present invention was produced in order to solve the above-described situation.

It is an object of the present invention to provide an electrostatic latent image developing toner exhibiting ultra-low temperature fixability together with high resolution, excellent fluidity and anti-blocking property, and excellent aging stability in a toner vessel, in which the toner is smoothly supplied into an image forming apparatus. Also disclosed is an electrostatic latent image developing toner possessing a resin, a colorant and an external additive, wherein the toner has a glass transition temperature (Tg) of 16-44° C.; the toner has an X-ray intensity ratio of titanium to silicon (Ti/Si) being 1.0-2.5, when the toner is analyzed via fluorescent X-ray analysis; and toner particles constituting the toner, and having a ratio of a 2^{nd} short axis to a 1^{st} short axis being 1.1-1.6 have an amount of 5-50% in terms of the number of particles, provided that a maximum length of a line segment between points A1 and A2 is designated as a long axis, of a toner particle when a closed curve to form a contour of a projection plane of at least one of the toner particles is held between two parallel lines so as to make contact with points A1 and A2; a line segment between points E1 and E2 is designated as the 1^{st} short axis of the toner particle when a midpoint of the line segment between points A1 and A2 is represented by point B, and points at the intersection of a perpendicular bisector of the line segment between points A1 and A2 passing through point B with the closed curve are represented by points E1 and B2, respectively; and a longer length of either a line segment between points C11 and C12 or a line segment between points C21 and C22 is designated as the 2^{nd} short axis of the toner particle when a midpoint of a line segment between points A1 and B is represented by point C1, and points at the intersection of a perpendicular bisector of the line segment between points A1 and B passing through point C1 with the closed curve are represented by points C11 and C12, respectively, and also a midpoint of a line segment between points A2 and B is represented by point C2, and points at the intersection of a perpendicular bisector of the line segment between points A2 and B passing through point C2 with the closed curve are represented by points C21 and C22, respectively.

After considerable effort during intensive studies, the inventors have found out that the foregoing problems can be solved by keeping properties of the electrostatic latent image developing toner (hereinafter, referred to simply as toner) appropriate, and also by combining appropriate selection of external additives for toner with the toner vessel shape.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a perspective view showing an example of a toner vessel;

FIG. 2 is a perspective view showing another example of a toner vessel;

FIG. 3 is a perspective view showing the other example of a toner vessel;

FIG. 4a, FIG. 4b and FIG. 4c each show a perspective view and an elevation view of the shape of a toner ejecting outlet;

FIG. 5 is a schematic illustration showing an example of toner shape; and

FIG. 6 is an illustrative cross-sectional view showing an image forming apparatus capable of using toner of the present invention.

### DETAILED DESCRIPTION OF THE INVENTION

A high-quality image trend has recently been noticeable, and in order to deal with this situation, utilized has been the toner having not only a small particle diameter together with a small particle diameter distribution width, but also having uniform particle shape.

The present invention was done to solve problems produced in the course of development of the toner exhibiting low temperature fixability, an anti-blocking property during toner storage, excellent electrification and so forth, further in addition to the small particle diameter in response to the high-quality image trend.

In the presently demanded high-quality image, in order to produce the toner exhibiting excellent low temperature fixability together with excellent electrification and an excellent anti-blocking property, it is desired that the toner has not only a small particle diameter together with a small particle diameter distribution width, but also having uniform particle shape, and has a low glass transition temperature (Tg), as well as a very high fluidity. However, in the case of supplying such the toner to a practical developing device to perform an evaluation test employing an image forming apparatus, when the toner leaks outside since the toner is supplied too much at a stretch during supplying of the toner, and is easy to be scattered, contaminations caused by the widespread scattering are generated because of extremely high fluidity. After fitting a toner vessel into an image forming apparatus, a stop mechanism is arranged to be set in such a way that the toner vessel can not be removed from the image forming apparatus but after completion of the toner supply. However, practically, it happens to remove the toner vessel in this case, and it also happens to accidentally remove the toner vessel.

It was also understood that the deposited toner underwent impact easily even in high fluidity, and blocking during the deposition was also easy, though the increase of temperature in the apparatus might be influenced since no toner could extend transversely in the inside of a toner storage portion when the toner flowed rapidly in the storage portion of a developing device. The toner having a low glass transition temperature together with high fluidity as described in the present invention undergoes the above-described pronounced tendency.

Therefore, though a supply mechanism should be taken care of, but it was found out that controlling of a toner ejecting outlet size of a toner vessel was extremely effective to reduce the contamination low despite the toner leakage, and to inhibit rapid toner supply into a developing device.

That is, the toner producing no practical problem can be utilized by storing the toner of the present invention in the toner vessel of the present invention to use the newly developed ultra-low temperature fixing toner.

Next, the toner of the present invention, compounds used in the toner, the mechanism of the toner vessel and so forth will be further described.

### [Electrostatic Latent Image Developing Toner of the Present Invention]

The toner of the present invention has a low glass transition temperature (Tg) of 16-44° C. in comparison to the Tg of the toner which is presently employed. The reason comes from the fact that a blocking problem during storage is produced even in application of the structure of the present invention in the case of a glass transition (Tg) of less than 16° C., and a problem of a low temperature fixing property is also produced in the case of a glass transition (Tg) exceeding 44° C.

In addition, glass transition temperature (Tg) of the present invention is measured by the following method.

### {Measurement of Glass Transition Temperature (Tg)}

The glass transition temperature can be measured employing a differential scanning calorimeter (DSC-7, produced by Perkin-Elmer Corp.) and a thermal analysis controller (TAC7/DX, produced by Perkin-Elmer Corp.).

In the operational procedure, 4.5-5.0 mg of a measured sample is weighed at a precision to two places of decimals and enclosed in an aluminum pan (KitNO. 0219-0041), and then seat onto “DSC-7 sample/holder”. Measurement for reference was performed using an empty aluminum pan. Temperature control of Heat-Cool-Heat is carried out under the conditions of a measurement temperature of 0-200° C., a temperature-increasing speed of 10° C./min and a temperature-decreasing speed of 1.0° C./min, and analysis is conducted based on the data of the 2nd Heat.

“Glass transition temperature” is designated as the temperature at an intersection point of an extension line of a base line before rising of the first endoergic peak and the tangential line shown at the maximum inclination in the range between the rising part of the first endoergic peak and the peak thereof.

As for toner particles, extremely uniform particle distribution and shape, together with a small particle diameter are desired to be employed in order to obtain high resolution, but the method of manufacturing toner is not specifically limited. In addition, presently available known binder resins and colorants are usable for toner.

However, a suitable particle shape distribution usable in the present invention preferably has the after-mentioned axis ratio. In this case, excellent cleaning ability and transferability lead to excellent halftone images, whereby high image quality is stably obtained.

### (Preferable Toner Particle Shape)

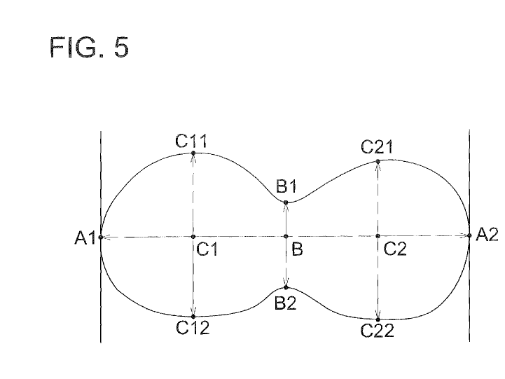

The toner particle shape of the present invention is defined, for example, by the method shown in FIG. 5.

Referring to FIG. 5, toner particles having a ratio of a 2^{nd} short axis to a 1^{st} short axis being 1.1-1.6 have an amount of 5-50% in terms of the number of particles, provided that a maximum length of a line segment between points A1 and A2 is designated as a long axis of a toner particle when a closed curve to form a contour of a projection plane of at least one of the toner particles is held between two parallel lines so as to make contact with points A1 and A2; a line segment between points B1 and B2 is designated as the 1^{st} short axis of the toner particle when a midpoint of the line segment between points A1 and A2 is represented by point B, and points at the intersection of a perpendicular bisector of the line segment between points A1 and A2 passing through point B with the closed curve are represented by points B1 and B2, respectively; and a longer length of either a line segment between points C11 and C12 or a line segment between points C21 and C22 is designated as the 2^{nd} short axis of the toner particle when a midpoint of a line segment between points A1 and B is represented by point C1, and points at the intersection of a perpendicular bisector of the line segment between points A1 and B passing through point C1 with the closed curve are represented by points C11 and C12, respectively, and also a midpoint of a line segment between points A2 and B is represented by point C2, and points at the intersection of a perpendicular bisector of the line segment between points A2 and B passing through point C2 with the closed curve are represented by points C21 and C22, respectively.

In order to measure shapes of toner particles, 500 random toner particles are sampled from toner particle photographs magnified at a factor of 5,000 employing a scanning electron microscope (SEM) to determine the shape, and to check whether or not it falls under the above-described condition.

### [External Additive]

Silica, titanium dioxide and composite metal oxide are usable as external additives.

Specifically, examples of commercially available silica include AEROSIL 50, AEROSIL 90G, AEROSIL 130, AEROSIL 200, AEROSIL 300, AEROSIL 380, AEROSIL TT600, AEROSIL MOX170, ARROSIL, MOX80 or AEROSIL COK84 (produced by Nippon Aerosil Co., Ltd.); Ca—O—SiL L-90, Ca—O—SiL LM130, Ca—O—SiL LM150, Ca—O—SiL M-5, Ca—O—SiL PTG, Ca—O—SiL MS-55, Ca—O—SiL, H-5, Ca—O—SiL HS-5 or Ca—O—SiL EH-5 (produced by Cabot Co.); WACKER HDK, WACKER N20, WACKER U15, WACKER N20E, WACKER T30, WACKER T40 (produced by WACKER=CHEMIE GMBH); D-C Fine Silica (produced by Dow Corning Corporation); and FRANSOL (produced by Fransil Co.). Examples of commercially available dry-process silica include ADMAFINE SO-E2, ADMAFINE SO-E3, ADMAFINE SO-C2, ADMAFINE SO-C3, ADMAFINE SO-C5 (produced by Admatechs Co.). Examples of commercially available wet-process silica include Carplex #67, Carplex #80, Carplex 4100, Carplex #1120, FPS-1, FPS-3, FPS-4 (produced by Shionogi & Co., Ltd.); and SEAHOSTAR (produced by Nippon Shokubai Co., Ltd.). Further, inorganic particles having a primary particle diameter of 0.1 μm prepared via sol-gel process are preferably usable.

Examples of titanium dioxide include commercially available anatase type titanium dioxide such as KA10, KA-15, KA-20, KA-30, KA-35, KA-80, KA-90 or STT-30 (produced by Titan Kogyo Co., Ltd.); rutile type titanium dioxide such as KR-310, KR-380, KR-460, KR-480, KR-270 or KV-300 (produced by Titan Kogyo Co., Ltd.); commercially available titanium dioxide such as MT-150A, MT-150A, MT-600B, MT-100S, MT-500B, JR-602S or JR-600A (produced by Tayca Corporation); and commercially available titanium dioxide such as P25 (produced by Nippon Aerosil Co., Ltd.).

Conventionally, inorganic particles are usable as external additives to assist fluidity, developability and electrification of toner particles. In the present, invention, silica particles and titanium dioxide particles are used in combination. These particles preferably have a primary particle diameter of 5-2000 nm, and more preferably have a primary particle diameter of 5-200 nm. The specific surface area obtained via the BET method was preferably 20-500 m²/g.

These silica particles and titanium dioxide particles preferably have a content of 0.01-5% by weight, based on the weight of toner, and more preferably a content of 0.01-2.0% by weight.

Incidentally, the primary particle diameter can be measured with a TEM (transmission electron microscope) or an FE-SEM (field emission scanning electron microscope). In addition, in the case of acicular or polyhedron particles, the major axis of the particle is designated as the primary particle diameter.

Degradation of fluidity and electrification can be prevented even at high humidity with such the fluidizer via surface treatment and increased hydrophobicity. Preferable N examples of the finishing agent include a silane coupling agent, a silylation agent, a silane coupling agent having an alkyl fluoride group, an organic titanate based coupling agent, an aluminum based coupling agent, silicone oil and modified silicone oil.

### Composite Metal Oxide Particle

The external additives of the present invention are composite metal oxide particles, and are composed of metal oxide such as amorphous silica, titanium dioxide or so forth It is preferable that the foregoing external additives are those in which amorphous silica and crystallized metal oxide are mixed and exhibit a sea-island structure in a region of at most 100 nm in size. Alternatively, the 3^{rd} external additive may be one in which the foregoing amorphous silica forms a core, and metal oxide is present on the surface of the core. Further, it may be one in which the foregoing crystallized metal oxide forms a core, and amorphous silica is present on the surface of the core.

As an example, the 3^{rd} external additive which is one in which the foregoing amorphous silica forms a core, and metal oxide is present on the surface of the core will be described in detail.

The external additive used for the present invention is composed of amorphous silica and metal oxide as described before, and it is preferable that metal oxide is present on the surface of amorphous silica, and the metal oxide is crystallized on the external additive surface.

The 3^{rd} external additive preferably has a number average primary particle diameter of 35-500 mm, and more preferably has a number average primary particle diameter of 40-300 nm in view of stabilizing charge on the toner surface, and also stabilizing the external additive itself further on the toner base body surface.

In addition, the number average primary particle diameter can be measured, employing a high resolution transmission electron microscope (HR-TEM). The horizontal Feret diameter of 100 random external additives was measured to calculate the arithmetic average. The particle selection is conducted by selecting external additives adhered to outline portions of toner particles.

Composite metal oxide particles of the present invention are preferably treated with a commonly known hydrophobic agent such as a silane coupling agent or silicone oil. A hexamethyldisilane compound is specifically preferable as a hydrophobic agent.

### {X-Ray Intensity Ratio of Titanium to Silicon (Ti/Si)}

In the present invention, the X-ray intensity ratio of titanium to silicon (Ti/Si), determined via fluorescent X-ray analysis, is 1.0-2.5. The X-ray intensity ratio of titanium to silicon (Ti/Si) was measured as described below.

### {Measuring Method of Fluorescent X-Ray Analysis (Wdx)}

Element contents of Ti and Si contained in toner can be measured employing a fluorescent X-ray analyzer (XRF-1700, manufactured by Shimadzu Corporation). Two grams of toner as a specimen was pressed and palletized to conduct measurement under the following conditions via qualitative analysis. In addition, a Kα peak angle of an element to be measured was determined from the 2θ table for the measurement.

X-ray generating portion condition: Target Rh; Tube voltage 40 kV; Tube current; 95 mA; and No filter.

Spectrometer condition: Standard slit; No attenuator; dispersive crystal (Ti=LiF and Si=PET); and Detector (Ti=SC and Si=FPC).

The ratio of Ti/Si was calculated as a value of Net intensity of TiKα analytical line divided by Net intensity of SiKα analytical line.

### [Electrostatic Latent Image Developing Toner Vessel]

The electrostatic latent image developing toner vessel is not specifically limited, provided that the cross-sectional area of an ejecting outlet opening, specified in the present invention, is 0.07-2.00 cm².

Next, preferable examples of shapes of the toner vessel and the ejecting outlet, and a method of sealing the ejecting outlet during storage and conveyance will be described.

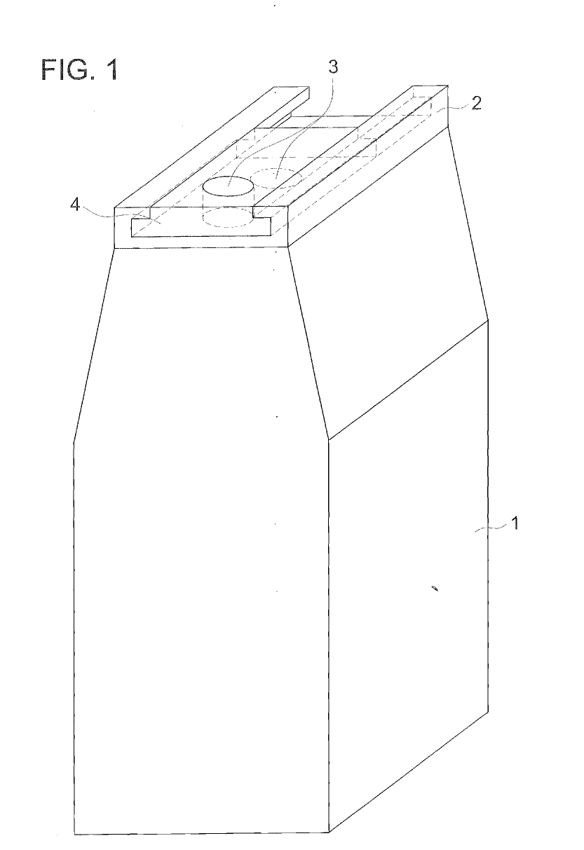

FIG. 1 is a perspective view showing an example of a toner vessel. Numeral 1 represents a toner vessel main body, 2 represents a toner ejecting section, and 3 represents a toner ejecting outlet. The toner ejecting outlet is to be covered, and sealed by some kind of method during storage and conveyance of the toner vessel in which toner is filled. As shown in FIG. 1, the toner ejecting outlet opening on toner vessel main body 1 and the toner ejecting outlet opening of sliding lid 4 are at a different position, and the toner ejecting outlets are sealed. When toner is supplied after installing a toner vessel in an image forming apparatus unshown figure), an opening can be created by sliding the sliding lid placed on the image forming apparatus to conform the ejecting outlet opening on the toner vessel main body to the ejecting outlet opening of the sliding lid. In addition, the term “toner ejecting outlet opening” here is an opening to form a rout for supplying a needed amount of toner into a toner storage hopper of an image forming apparatus from a toner vessel or a toner developing unit from the toner vessel.

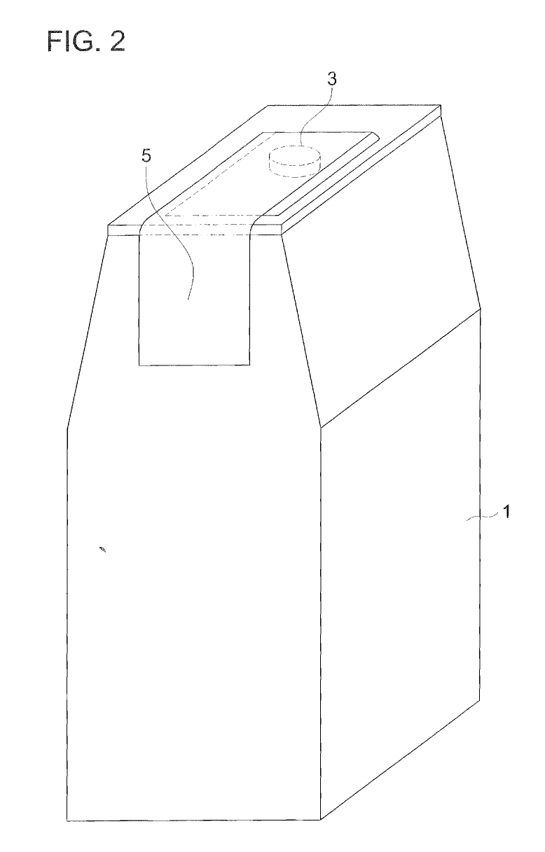

FIG. 2 is a perspective view showing another example of the toner vessel. The ejecting outlet is sealed with peel seal 5, and after installing a toner vessel in an image forming apparatus, peel seal 5 is peeled off to open the ejecting outlet. There are several practically available ways of how to peel off, but as shown in FIG. 2, the simplest is one in which the peel seal is folded back after adhesion so as to cover the ejecting outlet with the peel seal, the lingual part is arranged to be stuck out of a gap provided between the toner vessel and the image forming apparatus, and peel seal 5 is pealed via pulling, after installing the toner vessel in the image forming apparatus.

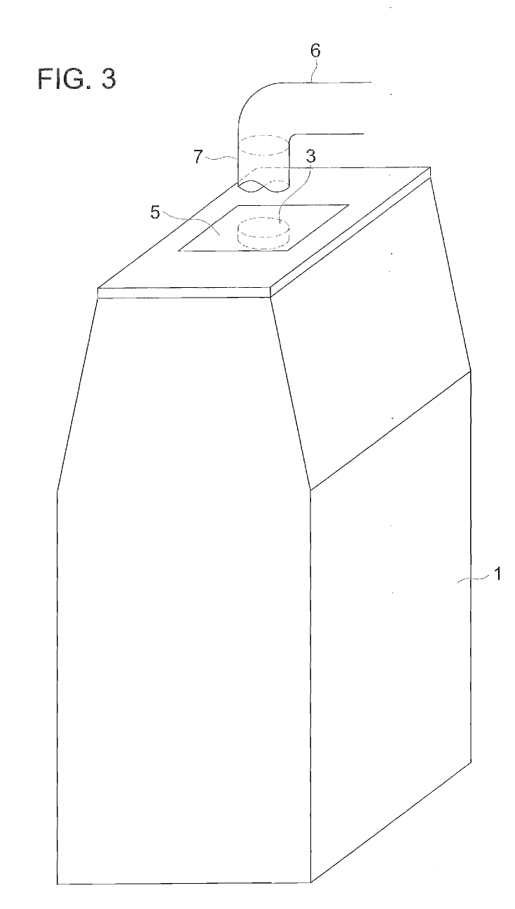

Further, as the other example shown in FIG. 3, a method of opening the toner ejecting outlet is also usable by breaking peel seal 5 attached to the toner ejecting outlet employing seal cutting member 7 equipped at the end of toner supply tube 6, for example, which is stuck out of the image forming apparatus.

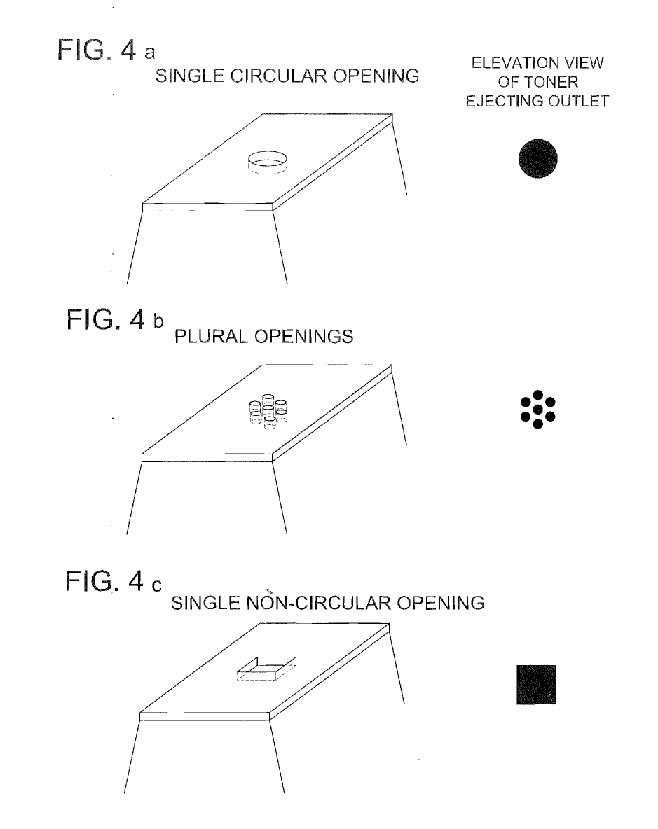

Each of FIG. 4a, FIG. 4b and FIG. 4c shows a perspective view and an elevation view of the shape of the toner ejecting outlet.

In FIG. 4a, the ejecting outlet is circular in shape. On the left is the perspective view relating to the toner vessel main body, and on the right is the elevation view showing the ejecting outlet shape for clarity.

FIG. 4b shows an example in which plural fine openings are provided, and FIG. 4c shows an example of the ejecting outlet having square shape. Even in the case of arranging plural ejecting outlets as shown in FIG. 4b, each of the ejecting outlets preferably has an ejecting outlet opening having a cross-sectional area of 0.07-2.00 cm².

As described above, any of the ejecting outlets preferably has an ejecting outlet opening having a cross-sectional area of 0.07-2.00 cm². In the case of a cross-sectional area of 0.07 cm² or less, image performance is deteriorated since toner during supply is damaged, and in the case of a cross-sectional area exceeding 2.00 cm², toner supply stability drops. In addition, the above-described cross-sectional area is more preferably 0.11-1.58 cm², and still more preferably 0.11-0.78 cm². The reason why an ejecting outlet of the toner vessel preferably has an ejecting outlet opening having a cross-sectional area of 0.07-2.00 cm² possesses the following two items.

1. A fitted portion between an ejecting outlet and an image forming apparatus is easily sealed, whereby leakage of toner scattered from peripheral gaps can be inhibited. In the case of the above-described cross-sectional area range, the toner can be stably supplied with no scattering during the transfer to the image forming apparatus main body.

2. The toner vessel can be repeatedly reused since the toner vessel offers greater flexibility to the sealing method, and specifically, no thermal deformation and wear can be observed at the sealed portion of the vessel, whereby no change of vessel dimensions is confirmed even after repetitive use.

### [Toner Material Used in the Present Invention]

As to the toner of the present invention, the method is not specifically limited, and a commonly known method is used.

However, toners obtained via a so-called polymerization method are preferred, but of these, the toner composed of spherical toner particles and non-spherical toner particles is specifically preferable in view of low glass transition temperature (Tg), together with excellent toner supply stability, excellent transferability and an excellent cleaning property. Concerning a method of manufacturing the toner, it is a feature that resin particles having a different glass transition temperature from that of resin particles added first are added in the middle of resin particle coagulation in the step of coagulating the resin particles to further conduct the coagulation continuously. It is preferable that the glass transition temperature of resin particles added later is higher than that of resin particles added first.

After this, the toner manufacturing method in which resin particles are first synthesized, and core/shell type toner particles are prepared via salting-out/fusion association of the resulting will be described.

The toner of the present invention is composed of at least a resin and a colorant, and is formed from a mixture of a non-spherical toner and a spherical toner, as mentioned before. Further, the toner of the present invention has a volume-based median particle diameter (D₅₀) in the foregoing range, and the toner having a small diameter to precisely reproduce fine dot images is preferably prepared by a polymerization method capable of controlling the particle diameter and shape in the preparation process. An emulsion association method, in which resin particles having a primary particle diameter of 60-300 nm are formed in advance by an emulsion polymerization method or such, and the toner is prepared via the step of forming particles having the foregoing particle diameter after the step of coagulating the resin particles, can be said to be a useful preparation method.

In the present invention, in the case of preparing toner via the emulsion association method, when the following operation is conducted in the step of coagulating resin particles, it is found out that the spherical toner and the foregoing non-spherical toner are formed at the same time. That is, it is an operation in which resin particles are newly added in the middle of coagulation of resin particles to further conduct the coagulation continuously. Resin particles having a different glass transition temperature from that of resin particles added first are added in the middle of resin particle coagulation in the step of coagulating the resin particles to further conduct the coagulation continuously, and the glass transition temperature of resin particles added later is preferably higher than that of resin particles added first.

The toner preparation via the emulsion association method as an example of a method of preparing the toner of the present invention will, be described below. The toner preparation by the emulsion association method will be conducted via the following steps.

(1) Preparation step of resin particle A dispersion

(2) Preparation, step of resin particle B dispersion

(3) Preparation step of colorant particle dispersion

(4) Coagulation/fusing step of resin particles

(5) Ripening step

(6) Cooling step

(7) Washing step

(8) Drying step

(9) External additive treating step Each of the steps is further detailed below.

### (1) Preparation Step of Resin Particle A Dispersion

resin particle A means resin particles first added into the reaction system in the after-mentioned coagulation step, and this step is a step of forming resin particles having roughly a size of 120 nm via polymerization by charging a polymerizable monomer to form resin particle A into an aqueous medium. Resin particle A is capable of forming one containing wax. In this case, resin particles formed by containing wax are formed by dissolving or dispersing wax in the polymerizable monomer to conduct polymerization in an aqueous medium.

### (2) Preparation Step of Resin Particle B Dispersion

Resin particle B means resin particles added in the middle of coagulation of resin particle A which has been first added into the reaction system in the above-mentioned coagulation step. The preparation method of resin particle B is basically similar the preparation method of resin particle A, but resin particle B has a different glass transition temperature from that of particle A. Resin particle B preferably has higher glass transition temperature than that of particle A.

### (3) Preparation Step of Colorant Particle Dispersion

This step is a step of preparing a dispersion of colorant particles having roughly 110 nm in size after dispersing the colorant in an aqueous medium

### (4) Coagulation/Fusing Step of Resin Particles

This step is a step of acquiring particles via fusion of coagulated particles after coagulation resin particles and colorant particles in an aqueous medium. This is a step corresponding to “the step of coagulating resin particles” described in the present invention.

In the step, as a coagulant, an alkali metal salt or an alkaline earth metal salt is added into an aqueous medium in which resin particles are colorant particles and colorant particles are present, and coagulation is promoted to fuse resin particle-to-resin particle at the same time by heating to a temperature higher than the glass transition temperature of the foregoing resin particles, and higher than melting peak temperature (° C.) of the foregoing mixture.

In this step, the toner of the present invention, formed from a mixture of spherical toner and non-spherical toner can be prepared by forming particles via the following procedure.

That is, resin particle A and colorant particles which have been prepared via the foregoing procedure are first added into the reaction system, and resin particle A is coagulated by adding magnesium chloride or such as a coagulant to form particles. Then, resin particle A added first and resin particle B having a different glass transition temperature are added in the middle of coagulation of resin particle B, and coagulation of resin particles is further conducted continuously.

Further, time to add resin particles is preferably as the final target a time at which a coagulated material composed of resin partial A added first reaches 30-50% of volume-based median particle diameter (D₅₀) of toner in size.

Coagulation is terminated at a time when the particle diameter has reached the target size by adding salt such as dietary salt and so forth. In addition, the addition amount of resin particle B preferably is preferably 2-90% by weight, based on the amount of resin particle A.

### (5) Ripening Step

This step following the above-described coagulation/fusing step is a step in which ripening is conducted until the particle shape reaches a desired degree of circularity.

### (6) Cooling Step

This step is a step of conducting a cooling treatment (rapid cooling) of a dispersion of the foregoing particles.

Cooling is performed at a cooling rate of 1-20° C./min as a cooling treatment condition. The cooling treatment is not specifically limited, and examples thereof include a method in which a refrigerant is introduced from the exterior of the reaction vessel to perform cooling and a method in which chilled water is directly supplied to the reaction system to perform cooling.

### (7) Washing Step

This step possesses a solid-liquid separation process to separate particles from a particle dispersion cooled to the prescribed temperature in the above-described step, and a washing process to remove an adhesion material such as a surfactant or a coagulant from particles aggregate in a wet cake form) via the solid-liquid separation.

Washing is conducted until the filtrate reaches a conductivity of 10 μS/cm. A filtration treatment is conducted, for example, by a centrifugal separation, filtration under reduced pressure using a Nutsche funnel or filtration using a filter press, but the treatment is not specifically limited.

### (8) Drying Step

In this step, washed particles are subjected to a drying treatment to obtain dried particles. Drying machines usable in this step include a spray dryer, a vacuum freeze-drying machine, and a vacuum dryer. Preferably used are a standing plate type dryer, a movable plate type dryer, a fluidized-bed dryer, a rotary dryer and a stirring dryer.

The moisture content of dried particles is preferably not more than 5% by weight, and more preferably not more than 2%. In addition, when particles to each other that have been subjected to a drying treatment are aggregated via weak attractive force between particles, the aggregate may be subjected to a pulverization treatment. Pulverization can be conducted employing a mechanical pulverizing apparatus such as a jet mill, HENSCHEL MIXER, coffee mill or food processor.

### (9) External Additive Treating Step

In this step, dried particles are optionally mixed with external additives to prepare toner. There are usable mechanical mixers such as a HENSCHEL MIXER, a coffee mill and so forth as the external additive mixer.

Next, a resin, a colorarnt, wax and so forth which are constituting toner of the present invention will be described referring to specific examples.

As the resin usable for toner of the present invention, employed can be a polymer obtained by polymerizing polymerizable monomers as described below.

The resin of the present invention contains a polymer obtained by polymerizing at least one polymerizable monomer as a constituent component, and examples of the foregoing polymerizable monomer include styrene or a styrene derivative such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene p-n-nonylstyrene, p-n-decylstyrene and p-n-docdecylstyrene; a methacrylate derivative such as methyl methacrylate, ethyl methacrylate, n-butyl methacrylate, iso-propyl methacrylate, iso-butyl methacrylate, n-octyl methacrylate, 2-ethylhexyl methacrylate, stearyl methacrylate, lauryl methacrylate, phenyl methacrylate, diethylaminoethyl methacrylate and dimethylaminoethyl methacrylate; an acrylate derivative such as methyl acrylate, ethyl acrylate, iso-propyl acrylate, n-butyl acrylate, t-butyl acrylate, iso-butyl acrylate, n-octyl acrylate, 2-ethylhexyl acrylate, stearyl acrylate, lauryl acrylate and phenyl acrylate; olefin such as ethylene, propylene and iso-butylene, a vinyl halide such as vinyl chloride, vinylidene chloride, vinyl bromide, vinyl fluoride and vinylidene fluoride; vinyl ester such as vinyl propionate, vinyl acetate and vinyl benzoate; vinyl ether such as vinyl methyl ether and vinyl ethyl ether; vinyl ketone such as vinyl methyl ketone, vinyl ethyl ketone and vinyl hexyl ketone; an N-vinyl compound such as N-vinylcarbazole, N-vinylindole and N-vinyl pyrrolidone; a vinyl compound such as vinylnaphthalene and vinylpyridine; and an acrylic acid or a methacrylic acid derivative such as acrylonitrile, methacrylonitrle and acrylamide. These vinyl based monomers may be used singly or in combination.

Further, it is more preferable that those having ionic dissociation groups as polymerizable monomers constituting resins are used in combination. Examples thereof are those each having a substituent such as carboxyl group, sulfonic acid group or phosphoric acid group as a constituting group of a monomer, and there are specifically given acrylic acid, methacrylic acid, maleic acid, itaconic acid, cinnamic acid, fumaric acid, monoalkyl maleate, monoalkyl itaconate, styrenesulfonic acid, allylsulfosuccinic acid, 2-acrylamido-2-methylpropanesulfonic acid, acidphosphoxyethyl methacrylate, 3-chloro-2-acidphosphoxypropyl methacrylate.

It is further possible to produce resins having a cross-linked structure by using polyfunctional vinyls such as divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol methacrylate, neopentyl glycol diacrylate, and the like.

Commonly known colorants may be listed as colorants usable for toner of the present invention. Specific colorants are shown below.

Black colorants are carbon black such as furnace black, channel, black, acetylene black, thermal black or lamp black, and magnet powder such as magnetite and ferrite.

Examples of colorants for magenta or red include C.I. pigment red 2, C.I. pigment red 3, C.I. pigment red 5, C.I. pigment red 6, C.I. pigment red 7, C.I. pigment red 15, C.I. pigment red 16, C.I. pigment red 48; 1, C.I. pigment red 53; 1, C.I. pigment red 57; 1, C.I. pigment red 122, C.I. pigment red 123, C.I. pigment red 139, C.I. pigment red 144, C.I. pigment red 149, C.I. pigment red 166. C.I. pigment red 177, C.I. pigment red 178, and C.I. pigment red 222.

Examples of colorants for orange or yellow include C.I. pigment orange 31, C.I pigment orange 43, C.I. pigment yellow 12, C.I. pigment yellow 13, C.I. pigment yellow 14, C.I. pigment yellow 15, C.I. pigment yellow 17, C.I. pigment yellow 93, C.I. pigment yellow 94, and C.I. pigment yellow 138.

Further, examples of colorants for green or cyan include C.I. pigment blue 15, C.I. pigment blue 15; 2, C.I. pigment blue 15; 3, C.I. pigment blue 15; 4, C.I. pigment blue 16, C.I. pigment blue 60, pigment blue 62, pigment blue 66, and C.I. pigment green 7.

These colorants can be used singly or at least two kinds of colorants can be selected in combination if desired. The addition amount of colorant is 1-30% by weight, based on the total amount of toner, and preferably 2-20% by weight.

Commonly known wax can be provided as one usable for toner of the present invention, and examples thereof include polyolefin wax such as polyethylene wax or polypropylene wax; long chain hydrocarbon wax such as paraffin wax or sazole wax; dialkyl ketone wax such as distearyl ketone or such; ester wax such as carnauba wax, montan wax, trimethylolpropane tribehenate, pentaerythritol tetrabehenate, pentaerythritol diacetate dibehenate, glycerin tribehenate, 1,18-octadecanediole distearate, trimellitic acid tristearyl, or distearylmaleate; and amide wax such as ethylene diaminebehenyl amide, or trimellitic acid tristearyl amide.

The melting point of wax usable in the present invention is preferably 40-160° C., more preferably 50-120° C., and still more preferably 60-90° C. A melting point falling within the foregoing range ensures heat resistant stability of toners, and can achieve stable toner image formation without causing cold offsetting even when fixed at a relatively low temperature. The wax content of the toner is preferably in the range of 1-30% by weight, and more preferably 5-20% by weight.

### [Image Forming Method and Image Forming Apparatus of the Present Invention]

The toner of the present invention may be used as a single-component developer or a two-component developer, but is specifically preferable as a two-component developer.

Next, ten image forming method in which the toner of the present invention is usable will be described. The toner of the invention is used in high-speed image forming apparatuses, for example, at a level of a printing rate of 100-400 mm/sec (corresponding to output performance of 65-85 sheet/min in A4 size sheet). Specifically, there are cited on-demand printers capable of preparing a large amount of documents for a short period. The present invention is also applicable to image forming methods in which the fixing roller temperature is not more than 120° C., and preferably not more than 100° C.

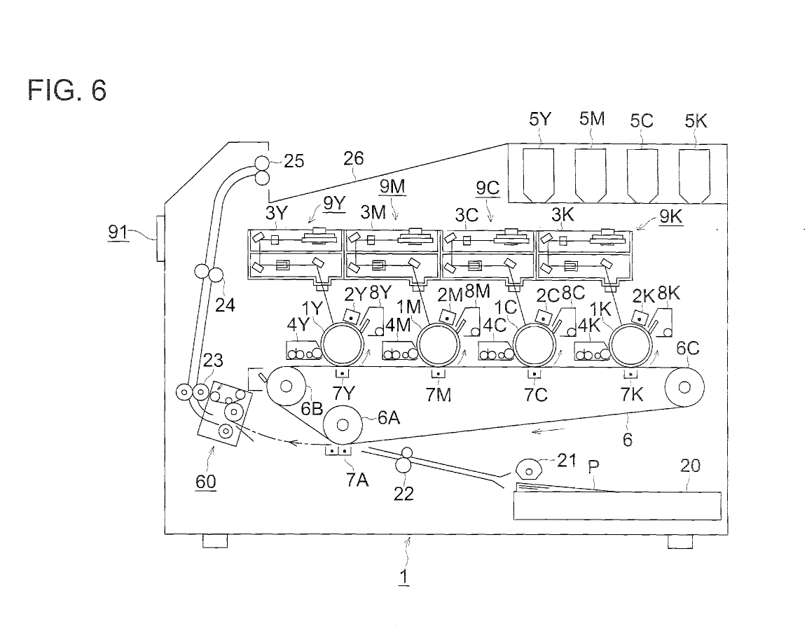

FIG. 6 illustrates one example of the image forming apparatus capable of using toner of the present invention, and shows an illustrative cross-sectional view.

As shown in FIG. 6, image forming apparatus 1 is called a tandem color image forming apparatus, which is composed of plural image forming units 9Y, 9M, 9C and 9K, belt-shaped intermediate transfer body 6, a paper feed device, a conveyance device, toner cartridges 5Y, 5M. 5C and 5K, fixing device 60 and operation section 91.

Image forming unit 9Y to form yellow images is equipped with an image carrier (hereinafter, referred to as photoreceptor) 1Y, and charging device 2Y, exposure device 3Y, developing device 4Y, transfer device 7Y and cleaning device BY which are placed around 1Y.

Image forming unit 9M to form magenta images is equipped with photoreceptor 1M, charging device 2M, exposure device 3M, developing device 4M, transfer device 7Y and cleaning device 8M.

Image forming unit 9C to form cyan images is equipped with photoreceptor 1C, charging device 2C, exposure device 3C, developing device 4C, transfer device 7C and cleaning device 8C.

Image forming unit 9K to form black images is equipped with photoreceptor 1K, charging device 2K, exposure device 3K, developing device 4K, transfer device 7K and cleaning device 8K.

Intermediate transfer body 6 is rolled in a plurality of rollers 6A, 6B and 6C, and is rotatably supported.

Color images formed by image forming units 9Y, 9M, 9C and 9K are each successively primarily transferred onto rotatable intermediate transfer body 6 to form a synthesized color image.

Paper P stored in paper feed cassette 20 as a paper feed device is fed by paper feed roller 21 one by one, and conveyed to transfer device 7A through resist roller 22 to secondarily transfer the foregoing color images onto paper P.

The foregoing paper P on which the color image is transferred is fixed by fixing device 6G as a fixing device of the present invention, nipped by paper discharge roller 25, and placed on paper discharge tray 26 outside the machine via conveyance rollers 23 and 24 as the conveyance device.

### EXAMPLE

Next, embodiments of the present invention are specifically described referring to examples, but the present invention is not limited thereto.

### 1. Preparation of Toner

Toner was prepared as described below.

### (1) Preparation of Colored Particle 1

### (Preparation of Resin Particle A1)

In a reaction vessel fitted with a stirrer, a temperature sensor, a condenser and a nitrogen gas introducing device, added were 8 parts by weight of sodium dodecylsulfate and 3000 parts by weight of deionized water, and the internal temperature was raised to 80° C., while stirring at a stirring speed of 230 rpm under a nitrogen gas stream. After raised to the said temperature, a polymerization initiator solution in which 10 parts by weight of potassium persulfate were dissolved in 200 parts by weight of deionized water was added into the system to adjust the liquid temperature to 80° C.

Next, after dripping a polymerizable monomer mixture solution composed of the compounds shown below in the reaction vessel for one hour, polymerization was conducted via heating at 80° C. for 2 hours while stirring to prepare resin particles designated as “resin particle (1H1)”.

| | |
|---|---|
| Styrene | 480 parts by weight |
| n-butylacrylate | 250 parts by weight |
| methacrylic acid | 68 parts by weight |
| n-octyl-3-mercaptopropionate | 16 parts by weight |

In a reaction vessel fitted with a stirrer, a temperature sensor, a condenser and a nitrogen gas introducing device, added was a solution in which 7 parts by weight of polyoxyethylene-2-dodecyl ether sodium sulfate was dissolved in 800 parts by weight of deionized water. After heating the reaction vessel to 98° C., 260 parts by weight of the foregoing “resin particle (1H1)” and a polymerizable monomer mixture solution composed of the compounds shown below are directly added to prepare a dispersion containing emulsified particles (oil droplets) employing a mechanical homogenizer having a circulation route (CLEARMIX, produced by M-Technique Co, Ltd.

| | |
|---|---|
| Styrene | 245 parts by weight |
| n-butylacrylate | 120 parts by weight |
| n-octyl-3-mercaptopropionate | 1.5 parts by weight |
| Polyethylene wax (melting point of 81° C.) | 190 parts by weight |

Next, a polymerization initiator solution in which 6 parts by weight of potassium persulfate were dissolved in 200 parts by weight of deionized water was added into this dispersion, and polymerization was conducted via heating at 82° C. for one hour while stirring to prepare resin particles designated as “resin particle (1HM1)”.

A polymerization initiator solution in which 11 parts by weight of potassium persulfate were dissolved in 400 parts by weight of deionized water was further added, and a polyimerizable monomer solution composed of the compounds shown below was dripped at 82° C. for one hour. Polymerization was conducted by heating for 2 hours while stirring after completion of dripping, and the system was subsequently cooled down to 28° C. to obtain resin particles designated as “resin particle A1”. The resulting “resin particle A1” had a glass transition temperature of 28° C.

| | |
|---|---|
| Styrene | 435 parts by weight |
| n-butylacrylate | 130 parts by weight |
| methacrylic acid | 33 parts by weight |
| n-octyl-3-mercaptopropionate | 8 parts by weight |

### (Preparation of Resin Particle B)

In a reaction vessel fitted with a stirred a temperature sensor, a condenser and a nitrogen gas introducing device, added were 2.3 parts by weight of sodium dodecylsulfate and 3000 parts by weight of deionized water, and the internal temperature was raised to 80° C., while stirring at a stirring speed of 230 rpm under a nitrogen gas stream. After raised to the said temperature, a solution in which 10 parts by weight of potassium persulfate were dissolved in 200 parts by weight of deionized water was added into the system to adjust the liquid temperature to 80° C. again, and a polymerizable monomer mixture solution composed of the compounds shown below was dripper spending one hour.

Polymerization was conducted by heating for 2 hours while stirring after completion of dripping, and the system was subsequently cooled down to 28° C. to obtain resin particles designated as “resin particle B”. The resulting “resin particle B” had a glass transition temperature of 48° C.

| | |
|---|---|
| Styrene | 520 parts by weight |
| n-butylacrylate | 210 parts by weight |
| methacrylic acid | 68 parts by weight |
| n-octyl-3-mercaptopropionate | 16 parts by weight |

### (Preparation of Colorant Dispersion 1)

Into 1600 parts by weight of deionized water, added were 90 parts by weight of sodium dodecylsulfate. Into the resulting solution, gradually added were 420 parts of carbon black (Regal 330R, produced by Cabot Co.), and subsequently dispersed employing a stirrer (CLEARMIX, M•Technique Co., Ltd.) to prepare a colorant particle dispersion designated as “colorant dispersion 1”. The particle diameter of colorant particles of “colorant dispersion 1”, which was measured with an electrophoretic light scattering photometer (ELS-800, produced by Otsuka Denshi Co., Ltd.), was 110 nm.

### (Coagulation/Fusing Step)

The following substances were added in a reaction vessel fitted with a stirrer, a temperature sensor, a condenser and a nitrogen gas introducing device to adjust the liquid temperature to 30° C.

| | |
|---|---|
| “Resin particle A1” | 300 parts by weight |
| (in terms of solid content conversion) | |
| Deionized water | 1400 parts by weight |
| “Colorant dispersion 1” | 120 parts by weight |

An aqueous solution in which 3 parts by weight of polyoxyethylene-2-dodecyl ether sodium sulfate was added into 120 parts by weight deionized water.

Next, the pH was adjusted to 10 by adding 5 mol/liter of an aqueous sodium hydroxide solution, and subsequently, an aqueous solution of 35 parts by weight of magnesium chloride dissolved in 35 parts by weight of deionized water was added, into the reaction system at 30° C. over 10 min while stirring. After being maintained for 3 minutes, the temperature was raised to 90° C. over 60 minutes to promote the coagulation. The coagulated particle size was observed with “Multisizer 3”.

When volume-based median particle diameter (D₅₀) reached 3.1 μm, 260 parts by weight (in terms of solid content conversion) of “Resin particle B” was added to further conduct continuous coagulation, and when volume-based median particle diameter (D₅₀) reached 6.5 μm, 750 parts by weight of an aqueous 20% sodium chloride solution were added to stop the coagulation.

After addition of the aqueous 20% sodium chloride solution, the liquid temperature was maintained at 98° C. while continuously stirring, and fusion of coagulated resin particles was promoted white observing circularity of the particle employing a flow system particle image analyzer “FPIA-2100”. When the circularity reached 0.965, the liquid temperature was cooled down to 30° C. to adjust the pH to 4.0 via addition of a hydrochloric acid and stop stirring.

Particles formed in the coagulation/fusing step were subjected to solid/liquid separation by using a basket type centrifugal separator (MARK III type No. 60×40, produced by Matsumoto Kikai Co., Ltd.) to form a wet cake of particles. The wet cake was washed with 45° C. deionized water by using the basket type centrifugal separator until the filtrate reached an electric conductivity of 5 μS/cm, transferred to “Flash Jet Dryer, produced by Seishin Enterprise Co., Ltd.” and dried until reached a moisture content of 0.5 by weight to prepare colored particle 1. In addition, as to colored particle 1, after sampling 128 particles at random, the shape was measured from a micrograph taken at a magnification of 2000 times, and particles having a ratio of the 2^{nd} short axis to the 1^{st} axis being 1.1-1.6 had a quantity of 46.9% in terms of the number of particles.

### (2) Preparation of Colored Particle 2

### (Preparation of Resin Particle A2)

In a reaction vessel fitted with a stirrer, a temperature sensor, a condenser and a nitrogen gas introducing device, added were 8 parts by weight of sodium dodecylsulfate and 3000 parts by weight of deionized water, and the internal temperature was raised to 80° C., while stirring at a stirring speed of 230 rpm under a nitrogen gas stream. After raised to the said temperature, a polymerization initiator solution in which 10 parts by weight of potassium persulfate were dissolved in 200 parts by weight of deionized water was added into the system to adjust the liquid temperature to 80° C.

Next, after dripping a polymerizable monomer mixture solution composed of the compounds shown below in the reaction vessel for one hour, polymerization was conducted via heating at 80° C. for 2 hours while stirring to prepare resin particles designated as “resin particle (1H2)”.

| | |
|---|---|
| Styrene | 495 parts by weight |
| n-butylacrylate | 235 parts by weight |
| methacrylic acid | 68 parts by weight |
| n-octyl-3-mercaptopropionate | 16 parts by weight |

In a reaction vessel fitted with a stirrer, a temperature sensor, a condenser and a nitrogen gas introducing device, added was a solution in which 7 parts by weight of polyoxyethylene-2-dodecyl ether sodium sulfate was dissolved in 800 parts by weight of deionized water. After heating the reaction vessel to 98° C., 260 parts by weight of the foregoing “resin particle (1H1)” and a polymerizable monomer mixture solution composed of the compounds shown below are directly added to prepare a dispersion containing emulsified particles (oil droplets) employing a mechanical homogenizer having a circulation route (CLEARMIX, produced by M-Technique Co., Ltd.).

| | |
|---|---|
| Styrene | 250 parts by weight |
| n-butylacrylate | 115 parts by weight |
| n-octyl-3-mercaptopropionate | 1.5 parts by weight |
| Polyethylene wax (melting point of 81° C.) | 190 parts by weight |

Next, a polymerization initiator solution in which 6 parts by weight of potassium persulfate were dissolved in 200 parts by weight of deionized water was added into this dispersion, and polymerization was conducted via heating at 82° C. for one hour while stirring to prepare resin particles designated as “resin particle (1HM2)”.

A polymerization initiator solution in which 11 parts by weight of potassium persulfate were dissolved in 400 parts by weight of deionized water was further added, and a polymerizable monomer mixture solution composed of the compounds shown below was dripped at 82° C. for one hour. Polymerization was conducted by heating for 2 hours while stirring after completion of dripping, and the system was subsequently cooled down to 28° C. to obtain resin particles designated as “resin particle A2”. The resulting “resin particle A2” had a glass transition temperature of 40° C.

| | |
|---|---|
| Styrene | 435 parts by weight |
| n-butylacrylate | 130 parts by weight |
| methacrylic acid | 33 parts by weight |
| n-octyl-3-mercaptopropionate | 8 parts by weight |

As to operations after this, “colored particle 2” was prepared similarly to preparation of “colored particle 1”, except that “resin particle B” and “colorant dispersion” in preparation of preparation of “colored particle 1” were employed. In addition, as to colored particle 2, after sampling 128 particles at random, the shape was measured from a micrograph taken at a magnification of 2000 times, and particles having a ratio of the 2, short axis to the 1^{st} axis being 1.1-1.6 had a quantity of 6.3% in terms of the number of particles.

Incidentally, no signal of a Si element and a Ti element was detected from any of colored particles.

### (External Additive Treating Step)

External additives (silica particles, titanium dioxide and composite metal oxide particles) were added into 100 parts of the resulting “colored particle 1” and “colored particle 2” as shown in the following Table 1.

After mixing the system under the conditions of 40 m/sec and 25° C. employing “10L Henschel mixer” manufactured by Mitsui Miike Kako-sha, coarse particles were removed using a sieve having an opening of 45 μm to prepare “Toners 1-1-1-11” formed from “colored particle 1” and “Toners 2-1-2-11” formed from “colored particle 2”. In addition, any of “Toners 1-1-1-11” had a glass transition temperature (Tg) of 32° C., and any of “Toners 2-1-2-11” had a glass transition temperature (Tg) of 42° C. In addition, as to “Toners 1-1-1-11”, particles having a ratio of the 2^{nd} short axis to the 1^{st} axis being 1.1-1.6 had the same quantity in terms of the number of particles as that of colored particle 1. Similarly, as to “Toners 2-1-2-11”, particles having a ratio of the 2^{nd} short axis to the 1^{st} axis being 1.1-1.6 had the same quantity in terms of the number of particles as that of colored particle 2.

As to “Toners 1-1-1-11” and “Toners 2-1-2-11”, the ratio of titanium to silicon external additive (Ti/Si in X-S439 ray intensity ratio) after adding external additive, which was determined via fluorescent X-ray analysis, is shown in Table 1.

TABLE 1

| | | External additive | | | | | | |
|---|---|---|---|---|---|---|---|---|
| | | | | | | | The 3rd | |
| | | | | | | | compo- | |
| | | | | | | | nent | Ratio of |
| | | | | | | | Composite | Ti/Si |
| | | Silica | | | | Titanium | metal | (Fluorescent |
| | | Silica A | Silica B | Silica C | Silica D | dioxide | oxide | X-ray |
| | | Primary | Primary | Primary | Primary | Primary | Primary | analysis |
| | | particle | particle | particle | particle | particle | particle | intensity |
| Colored | Toner | diameter | diameter | diameter | diameter | diameter | diameter | ratio) |
| particle | No. | 10 nm | 12 nm | 15 nm | 30 nm | 20 nm | 50 nm | (Ti/Si) |
| Colored | 1-1 | 1.00 | — | — | 0.50 | 0.30 | 0 | 0.52 |
| particle 1 | 1-2 | | 0.60 | — | 0.80 | 0.80 | 0 | 1.10 |
| (Tg 32° C.) | 1-3 | — | — | 1.30 | — | 0.40 | 0.60 | 0.90 |
| | 1-4 | — | 1.00 | — | — | 0.60 | 0.80 | 2.40 |
| | 1-5 | — | — | 1.00 | — | 0.40 | 0.80 | 1.53 |
| | 1-6 | — | — | 1.30 | — | 0.40 | 0.60 | 1.10 |
| | 1-7 | — | — | 1.00 | — | 0.60 | 0.80 | 2.08 |
| | 1-8 | — | — | 1.30 | — | 0.40 | 0.60 | 1.19 |
| | 1-9 | — | — | 1.30 | — | 0.60 | 0.80 | 1.64 |
| | 1-10 | — | — | 1.00 | — | 0.60 | 1.20 | 2.52 |
| | 1-11 | — | — | 1.00 | — | 1.50 | 0.60 | 3.07 |
| Colored | 2-1 | 1.10 | — | — | 0.50 | 0.40 | 0 | 0.54 |
| particle 2 | 2-2 | | 0.60 | — | 0.75 | 0.80 | 0 | 1.15 |
| (Tg 42° C.) | 2-3 | — | — | 1.30 | — | 0.60 | 0.60 | 0.92 |
| | 2-4 | — | 1.00 | — | — | 0.60 | 0.80 | 2.38 |
| | 2-5 | — | — | 1.00 | — | 0.40 | 0.80 | 1.55 |
| | 2-6 | — | — | 1.30 | — | 0.40 | 0.80 | 1.10 |
| | 2-7 | — | — | 1.00 | — | 0.60 | 0.80 | 2.10 |
| | 2-8 | — | — | 1.30 | — | 0.40 | 0.60 | 1.15 |
| | 2-9 | — | — | 1.30 | — | 0.60 | 0.80 | 1.60 |
| | 2-10 | — | — | 1.00 | — | 0.60 | 1.20 | 2.55 |
| | 2-11 | — | — | 1.00 | — | 1.50 | 0.60 | 3.15 |

{External additives represented by the number (parts), which are added into 100 parts of “colored particle 1” and “colored particle 2” are shown in the above Table 1.}

Silica A described in Table 1 is prepared via a dry method, and has silica particles having a primary particle diameter of 10 nm which have been subjected to a surface treatment with octylmethoxysilane. Similarly, Silica B described in Table 1 is also prepared via a dry method, and is silica particles having a primary particle diameter of 12 nm which have been subjected to a hydrophobic treatment with 1,1,1,3,3,3-hexamethyldisilazane. Further, Silica C described in Table 1 is prepared via a dry method, and is silica particles having a primary particle diameter of 15 nm which have been subjected to a hydrophobic treatment with 1,1,1,1,3,3,3-hexamethyldisilazane. In the same way, Silica D described in Table 1 is prepared via a dry method, and is silica particles having a primary particle diameter of 30 nm which have been subjected to a hydrophobic treatment with 1,1,3,3,3-hexamethyldisilazane. On the other hand, titanium dioxide described in Table 1 is anatase-type titanium dioxide particles having a primary particle diameter of 20 nm. Composite metal oxide is composite metal oxide particles containing titanium and silicon, which have been subjected to a hydrophobic treatment with a hexamethyldisilane compound, and has a structure in which crystallized titanium dioxide is present on the surface of a core made of amorphous silica. In this case, an X-ray intensity ratio of Ti to Si determined via fluorescent X-ray analysis was 2.87.

[Evaluation of Toner in Combination with Toner Vessel]

Toner 1 samples in combination with toner vessels and Toner 2 samples in combination with toner vessels as indicated in the following Table 2 were evaluated.

### (Evaluation Method)

### Solid Image Stability

The image density in the highest density solid image portion of each color was measured in relative reflection density employing a Macbeth reflection densitometer “PD-918” when a white portion of a transfer sheet was set to 0 in density.

A: The density is at least 1.2; (Excellent).

B: The density is at least 0.8; (practically with no problem).

C: The density is less than 0.8; (practically with problem)

### Fog in High Consumption Mode

A high image pattern having an image ratio of 85% was selected, 200 paper sheets were continuously printed in heavy duty mode of repetitive toner replacement, and density at non-image portions of the 200^{th} paper sheet, which is so-called fog, was measured to evaluate fog.

The absolute density of non-printed paper (white paper) was measured at 20 points and the average of measured values was defined as the density of white paper. Then, the absolute density of the white image portion of the printed image was measured at 20 points and the average value was calculated. The difference of the average density and the density of the foregoing white paper was evaluated as fog density. Measurement was done employing a Macbeth reflection densitometer “RD-918”.

A: The fog density is 0.005 or less; (Excellent).

B: The fog density is 0.01 or less; (Practically with no problem)

C: The fog density is more than 0.01; (Practically with problem).

### Halftone Image Uniformity (Halftone Density Unevenness)

The halftone density unevenness was determined as the density difference of halftone image (subtraction of minimum density from maximum density).

A: The density is 0.05 or less; (Excellent).

B: The density is more than 0.05 and less than 1; (Practically with no problem).

C: The density is 0.1 or more; (Practically with problem).

TABLE 2

| | | | | | Performance | | | |
|---|---|---|---|---|---|---|---|---|
| | | Toner vessel | | | | | Image quality | |
| | | | | Ejecting | | Supply stability | stability Half | Inside or |
| | | Ejecting | Ejecting | outlet cross- | | Fog in high | image uniformity | outside the |
| Experi- | Toner | outlet | outlet | sectional | | consumption mode | 5000 sheets | present |
| ment No. | No. | structure | shape | area cm² | *1 | sheets printed | printed | invention |
| 1-1 | 1-1 | FIG. 1 | FIG. 4a | 0.785 | C | C | C | Outside |
| 1-2 | 1-2 | FIG. 2 | FIG. 4b | 0.882 | B | A | B | Inside |
| 1-3 | 1-3 | FIG. 2 | FIG. 4a | 0.785 | C | C | B | Outside |
| 1-4 | 1-4 | FIG. 1 | FIG. 4a | 0.785 | B | A | B | Inside |
| 1-5 | 1-5 | FIG. 1 | FIG. 4a | 0.785 | A | A | A | Inside |
| 1-6 | 1-6 | FIG. 1 | FIG. 4a | 0.785 | B | A | A | Inside |
| 1-7 | 1-7 | FIG. 1 | FIG. 4a | 0.785 | A | A | A | Inside |
| 1-8 | 1-8 | FIG. 1 | FIG. 4a | 0.080 | A | B | A | Inside |
| 1-9 | 1-9 | FIG. 1 | FIG. 4a | 0.785 | A | A | B | Inside |
| 1-10 | 1-9 | FIG. 1 | FIG. 4a | 0.052 | C | Unmeasurable | Unmeasurable | Outside |
| 1-11 | 1-9 | FIG. 2 | FIG. 4b | 2.20 | C | C | C | Outside |
| 1-12 | 1-10 | FIG. 1 | FIG. 4a | 0.785 | B | C | C | Outside |
| 1-13 | 1-11 | FIG. 1 | FIG. 4a | 0.785 | C | C | C | Outside |
| 2-1 | 2-1 | FIG. 1 | FIG. 4a | 0.785 | C | C | C | Outside |
| 2-2 | 2-2 | FIG. 2 | FIG. 4b | 0.882 | B | A | B | Inside |
| 2-3 | 2-3 | FIG. 2 | FIG. 4a | 0.785 | C | C | B | Outside |
| 2-4 | 2-4 | FIG. 1 | FIG. 4a | 0.785 | A | A | B | Inside |
| 2-5 | 2-5 | FIG. 1 | FIG. 4a | 0.785 | A | A | A | Inside |
| 2-6 | 2-6 | FIG. 1 | FIG. 4a | 0.785 | A | B | A | Inside |
| 2-7 | 2-7 | FIG. 1 | FIG. 4a | 0.785 | A | A | A | Inside |
| 2-8 | 2-8 | FIG. 1 | FIG. 4a | 0.080 | B | A | A | Inside |
| 2-9 | 2-9 | FIG. 1 | FIG. 4a | 0.785 | A | A | B | Inside |
| 2-10 | 2-9 | FIG. 1 | FIG. 4a | 0.052 | C | Unmeasurable | Unmeasurable | Outside |
| 2-11 | 2-9 | FIG. 2 | FIG. 4b | 2.20 | C | C | C | Outside |
| 2-12 | 2-10 | FIG. 1 | FIG. 4a | 0.785 | C | C | C | Outside |
| 2-13 | 2-11 | FIG. 1 | FIG. 4a | 0.785 | C | C | C | Outside |

*1: Supply stability 100 sheet continuous printing solid image stability

No density drop is observed even though solid images are continuously formed, and No fog is generated even in a mode in which the stirring time in a developing device is varied, together with heavy-duty consumption, that is, repetitive replacement of the toner by falling a Ti/Si ratio of the toner, a glass transition temperature (and toner particle shape) into the range of the present invention. Further, halftone density unevenness was possible to be controlled and minimized since the toner is transferred to an image forming apparatus, maintaining high transferability of the toner, whereby degradation of transferability can be controlled even in the image forming apparatus.

As is clear from Table 2, it is to be understood that any of properties of the present invention exhibits no practical problem, but at least some of the properties outside the present invention exhibit a practical problem.

In the present invention, provided can be an electrostatic latent image developing toner exhibiting ultra-low temperature fixability together with high resolution, excellent fluidity and anti-blocking property, and excellent aging stability in a toner vessel, in which the toner is smoothly supplied into an image forming apparatus.

What is claimed is:

1. An electrostatic latent image developing toner comprising a resin, a colorant and an external additive,
wherein the toner has a glass transition temperature (Tg) of 16-44° C.;
the toner has an X-ray intensity ratio of titanium to silicon (Ti/Si) being 1.0-2.5 when the toner is analyzed via fluorescent X-ray analysis; and
toner particles constituting the toner, and having a ratio of a 2^{nd} short axis to a 1^{st} short axis being 1.1-1.6 have an amount of 5-50% in terms of the number of particles, provided that a maximum length of a line segment between points A1 and A2 is designated as a long axis of a toner particle when a closed curve to form a contour of a projection plane of at least one of the toner particles is held between two parallel lines so as to make contact with points A1 and A2; a line segment between points B1 and B2 is designated as the 1^{st} short axis of the toner particle when a midpoint of the line segment between points A1 and A2 is represented by point B, and points at the intersection of a perpendicular bisector of the line segment between points A1 and A2 passing through point B with the closed curve are represented by points B1 and B2, respectively; and a longer length of either a line segment between points C11 and C12 or a line segment between points C21 and C22 is designated as the 2^{nd} short axis of the toner particle when a midpoint of a line segment between points A1 and B is represented by point C1, and points at the intersection of a perpendicular bisector of the line segment between points A1 and B passing through point C1 with the closed curve are represented by points C11 and C12, respectively, and also a midpoint of a line segment between points A2 and B is represented by point C2, and points at the intersection of a perpendicular bisector of the line segment between points A2 and B passing through point C2 with the closed curve are represented by points C21 and C22, respectively.

2. The electrostatic latent image developing toner of claim 1,
wherein the toner comprises silica, titanium dioxide and composite metal oxide as the external additive.

3. The electrostatic latent image developing toner of claim 1,
wherein the toner comprises silica and titanium dioxide as the external additive, and
each of the silica and the titanium dioxide has a specific surface area obtained via a BET method being from 20-500 m²/g.

4. The electrostatic latent image developing toner of claim 1,
wherein the toner comprises silica and titanium dioxide as the external additive in an amount of 0.01-5% by weight, based on the weight of the toner.

5. The electrostatic latent image developing toner of claim 4,
wherein the amount of silica particles and the titanium dioxide particles is 0.01-2.0% by weight, based on the weight of the toner.

6. An electrostatic latent image developing toner stored in a vessel comprising an ejecting outlet, capable of fitting into an image forming apparatus,
wherein the ejecting outlet opening has a cross-sectional area of 0.07-2.00 cm²;
the toner comprises a resin, a colorant and an external additive; the toner has a glass transition temperature (Tg) of 16-44° C.;
the toner has an X-ray intensity ratio of titanium to silicon (Ti/Si) being 1.0-2.5 when the toner is analyzed via fluorescent X-ray analysis; and
toner particles constituting the toner, and having a ratio of a 2^{nd} short axis to a 1^{st} short axis being 1.1-1.6 have an amount of 5-50% in terms of the number of particles, provided that a maximum length of a line segment between points A1 and A2 is designated as a long axis of a toner particle when a closed curve to form a contour of a projection plane of at least one of the toner particles is held between two parallel lines so as to make contact with points A1 and A2; a line segment between points B1 and B2 is designated as the 1^{st} short axis of the toner particle when a midpoint of the line segment between points A1 and A2 is represented by point B, and points at the intersection of a perpendicular bisector of the line segment between points A1 and A2 passing through point B with the closed curve are represented by points B1 and B2, respectively; and a longer length of either a line segment between points C11 and C12 or a line segment between points C21 and C22 is designated as the 2^{nd} short axis of the toner particle when a midpoint of a line segment between points A1 and B is represented by point C1, and points at the intersection of a perpendicular bisector of the line segment between points A1 and B passing through point C1 with the closed curve are represented by points C11 and C12, respectively, and also a midpoint of a line segment between, points A2 and B is represented by point C2, and points at the intersection of a perpendicular bisector of the line segment between points A2 and B passing through point C2 with the closed curve are represented by points C21 and C22, respectively.

7. The electrostatic latent image developing toner of claim 6,
wherein the toner comprises silica, titanium dioxide and composite metal oxide as the external additive.

8. The electrostatic latent image developing toner of claim 6,
wherein the toner comprises silica and titanium dioxide as the external additive, and
each of the silica and the titanium dioxide has a specific surface area obtained via a BET method being from 20-500 m²/g.

9. The electrostatic latent image developing toner of claim 6,
wherein the toner comprises silica and titanium dioxide as the external additive in an amount of 0.01-5% by weight, based on the weight of the toner.

10. The electrostatic latent image developing toner of claim 9,
wherein the amount of the silica particles and the titanium dioxide particles is 0.01-2.0% by weight, based on the weight of the toner.

11. A vessel for detachably mounted to an image forming apparatus, the vessel comprising
a toner vessel main body to store an electrostatic latent image developing toner of claim 1,
an ejecting outlet opening having a cross-sectional area of 0.07-2.00 cm² to elect the toner into the image forming apparatus when the vessel is mounted to the image forming apparatus.

12. The vessel of claim 11, comprising a sealing portion to open or close the ejecting outlet opening.

13. The vessel of claim 11,
wherein the toner comprises silica, titanium dioxide and composite metal oxide as the external additive.
